(19) United States
(12) Patent Application Publication
(10) Pub. No.: US 2002/0080198 A1
(43) Pub. Date: Jun. 27, 2002

(54) System for real-time location of people in a fixed environment

(75) Inventors: Patrick W. Giraldin, Irvine, CA (US); Regan E. Kelly, Laguna Niguel, CA (US); Timothy W. Giraldin, Aliso Viejo, CA (US)

Correspondence Address: Bernard L. Kleinke, Foley & Lardner, 23rd Floor, 402 West Broadway, San Diego, CA, 92101-3542, US

(73) Assignee: SafeTzone Technologies Corporation

(21) Appl. No.: 09/992,668

(22) Filed: Nov. 13, 2001

Related U.S. Application Data
(60) Provisional application No. 60/248,188, filed on Nov. 14, 2000.

(51) Int. Cl. G09G 5/00

(52) U.S. Cl. 345/864

(57) ABSTRACT

A system is provided for tracking in real-time the location of a group of individuals within a defined environment, for providing information to an individual user about the location of any other individuals of the group and for gaining assistance to locate and reunite lost individuals. The system uses an identification tag with a serial number worn by each individual of the group, has means for communicating with each tag as it moves with the individual through the environment and means for using the communication to determine the position of the tag in the environment. The system also uses strategically placed identification stations distributed within the environment for users to activate a request that the system locate members and for displaying a map indicating the location of members of the group.

### RELATED APPLICATIONS

The present application claims priority under 35 U.S.C. §119(e) to U.S. Provisional Patent Application Serial No. 60/248,188, filed Nov. 14, 2000, which is hereby incorporated by reference in its entirety. Further, the following application is also related to the present invention and is hereby incorporated by reference in its entirety: U.S. patent application, Attorney Docket No. 025505-2004, titled “IDENTIFICATION TAG FOR REAL-TIME LOCATION OF PEOPLE,” filed concurrently herewith.

### BACKGROUND OF THE INVENTION

1. Field of the Invention

The present invention relates generally to tracking systems, and more specifically to track in real time the location of individuals of a group within a defined environment such as a theme park or other such fixed activity environment.

2. Related Art

Systems and equipment necessary for tracking a group of individuals in real-time within a defined environment such as a theme park provide several challenges. The system should be able to distinguish every individual in the park and separately track their movement continuously or as needed within the environment and ideally should be able to locate members of the group within seconds of separation if either becomes lost or separated. For this purpose, the system should provide convenient access anywhere within the environment no matter how large and should operate effectively regardless of the extent of crowding. The system also should be accurate and provide updates on location every second or so as desired. This is particularly important in tracking fast moving children who become separated from their parents.

Systems and equipment for tracking the location of moving objects such as people in real time have been described (see, e.g., U.S. Pat. Nos. 5,764,283 and 5,973,732), however, the inventor is not aware of any description that satisfies the requirements discussed above. Many prior systems are based on tracking by comparing video frames taken at different times. A video directed approach, however, is suited only for tracking individuals in a very limited space such as the threshold of a store. Systems that use a tagging device attached to the individual for communication via radio frequency transmission and receipt also have been described, however, such devices are used primarily for controlling portal entry to a secured area.

Thus, it would be useful to have a system and equipment for tracking individuals of a group in real time within a confined environment and to provide information to any of the group members as to the whereabouts of the other members of the group. Such system would be advantageous particularly in large areas such as theme parks, casinos, and the like.

### BRIEF DESCRIPTION OF THE DRAWINGS

In the following the invention will be explained in further detail in conjunction with embodiment examples depicted in the drawings, in which:

FIG. 1 is a diagrammatic view of a tracking system according to one embodiment of the present invention illustrating monitoring sites, cell controllers (“cell cont.”), host computer, identification stations and tags and an example of communication therebetween;

FIG. 2 is a diagrammatic view of a graphical user interface (GUI) showing a video screen and selection buttons according to an embodiment of the invention;

FIG. 3 depicts a dialog box displayed on a GUI of an identification station according to an embodiment of the invention, showing an entered tag serial number and various selection buttons;

FIG. 4 depicts a dialog box displayed on a GUI of an identification station according to an embodiment of the invention, providing buttons for indicating whether the user is lost or whether the user is looking for another individual of a group;

FIG. 5 depicts a dialog box displayed on a GUI of an identification station according to an embodiment of the invention, showing an example of a map of an environment covered by the tracking system;

FIG. 6 depicts a dialog box displayed on a GUI of an identification station according to an embodiment of the invention, showing an example of a map of an environment indicating the locations of individual members of a group on the map by a picture of the individual;

FIG. 7 is a flow chart illustrating the flow of information from an identification station to a host computer when an individual selects a “Find” function at the identification station;

FIG. 8 is a flow chart illustrating the flow of information from an identification station to a host computer when an individual selects a “Lost” function at the identification station;

FIG. 9a illustrates a dialog box in a group building mode displayed on a GUI at a registration station according to the present invention;

FIG. 9b is a flow chart illustrating the building of a group on the GUI of FIG. 9a;

FIG. 10a illustrates a dialog box in a group finding mode displayed on a GUI at a registration station according to the present invention;

FIG. 10b is a flow chart illustrating the finding of a group on the GUI of FIG. 10a;

FIG. 11a illustrates a dialog box in a tag returning mode displayed on a GUI at a registration station according to the present invention;

FIG. 11b is a flow chart illustrating the turning in of a tag on the GUI of FIG. 11a;

FIG. 12a illustrates a dialog box in a tag swapping mode displayed on a GUI at a registration station according to the present invention;

FIG. 12b is a flow chart illustrating the swapping of a tag on the GUI of FIG. 12a;

FIG. 13a illustrates a dialog box in a group changing mode displayed on a GUI at a registration station according to the present invention; and

FIG. 13b is a flow chart illustrating the moving of an individual from one group to another on the GUI of FIG. 13a.

### DESCRIPTION OF CERTAIN EMBODIMENT OF THE INVENTION

The present invention provides a system for tracking in real-time the location of a group of individuals within a fixed environment and providing individuals of the group with the ability to locate any other individuals of the group. In general, a system according to one embodiment of the invention includes: (a) an identification tag worn by each individual of a group; (b) means for communicating with each tag as it moves with the individual through the environment and means for using the communication to determine the position of the tag in the environment; (c) identification stations distributed within the environment, the stations providing a “Locate” function or other means for activating a request that the system locate members of the group; (d) means for receiving the activation request from each location and for generating a map showing the location of each group member on the map; and (e) means for displaying the map at the ID station.

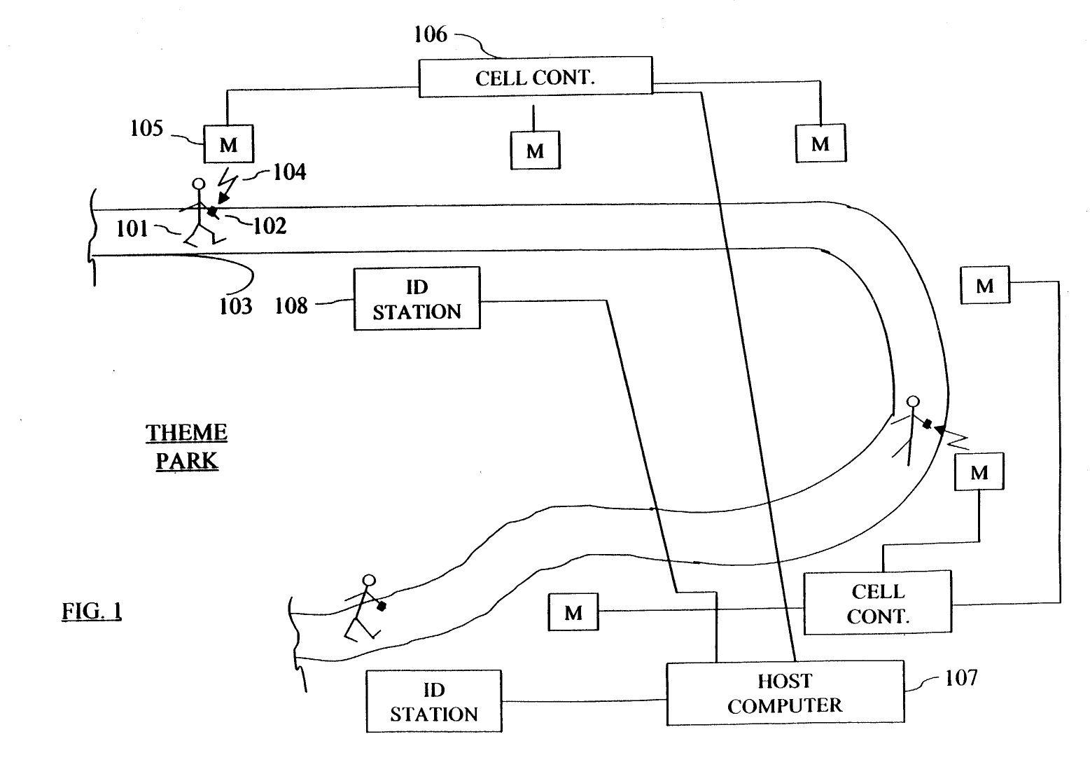

Briefly, an individual who carries an identification tag and is interested in determining the location of another individual of the group approaches an identification station which acts as a kiosk for participants of the system. The individual user provides the system with his/her tag serial number, which activates a search to retrieve the tag information, along with information relating to all other tags in the group and locate the position of each tag in the environment. This is accomplished by sending the desired tag serial numbers, or other tag identifier information, to cell controllers which send out a radio signal containing the tag serial number through a monitoring site and antenna. The person wearing the proper identification tag receives the signal and the tag responds with a radio signal (at different frequency from that first sent) that includes the tag serial number, for example. The signal is received at the monitoring sites and relayed to the cell controllers. A tag-to-antenna distance based on the time between sending the signal and receiving the signal from the Tag is calculated and used to determine the location of each individual in the environment. This information is sent to the identification station which displays the location of each individual on a map. Further details and various other embodiments of the present system are provided in FIGS. 1-8 as discussed below.

FIG. 1 is a diagrammatic view of an embodiment of the tracking system as applied to theme park. Individual 101 with an identification tag 102 walking on path 103 in the park comes in contact with radio signal 104 sent by antenna at monitoring site 105. The identification tag 102 responds with a radio signal (not shown) that is received by monitoring site 105 that communicates with a cell controller 106. The cell controller 106 communicates with a host computer 107, which communicates with an identification station 108.

Identification stations 108 may act as a kiosk for tagged users of the system to access and use its service properties. The identification stations 108 are strategically placed in the environment to provide ready access by identification tag users. The identification station 108 has a CPU and a graphical user interface (GUI), preferably a touch screen monitor or a display with a control such as a mouse. The identification station 108 provides the user with the ability to locate and view the position of any identification tag in the group, to post messages on a private message board or to contact security, for example.

Suggested platform requirements of an identification station include:

ViewPoint 2.0 with Service Pack 3

Win 95

Win 98

NT 4 (Service Pack 5)

Win 2000

Suggested minimum hardware requirements of an identification station include:

233 Pentium III with 128 MB RAM

800 by 600 resolution

Tags suitable for use in the system of the invention are well known in the art and are available commercially such as the “3-D-Id” tag system sold by Pinpoint Corporation, having a place of business at Billerica, Mass. Such tags can receive spread spectrum radio signals from monitoring site antennae and respond with a signal that includes the tag serial number. The tag can be read at long ranges compared to conventional radio frequency identification (RFID) systems. The tags are worn on the person preferably with a safety latch to impede easy removal.

Tags are provided to each participating member of a group when they arrive at the environment. Each individual is given an individual identification tag with its unique serial number. The identification tag serial number of the individual as well as the identification tag serial numbers of the other members of the individual's group are stored in the host computer or a server connected thereto. This aspect of the invention is described in further detail below. In a preferred embodiment, a digital picture is taken of the individual and stored in the computer along with the tag serial number of the individual. The software of the host computer stores each identification tag serial number with a link or in a table with all the other identification tag numbers of the other members of the group.

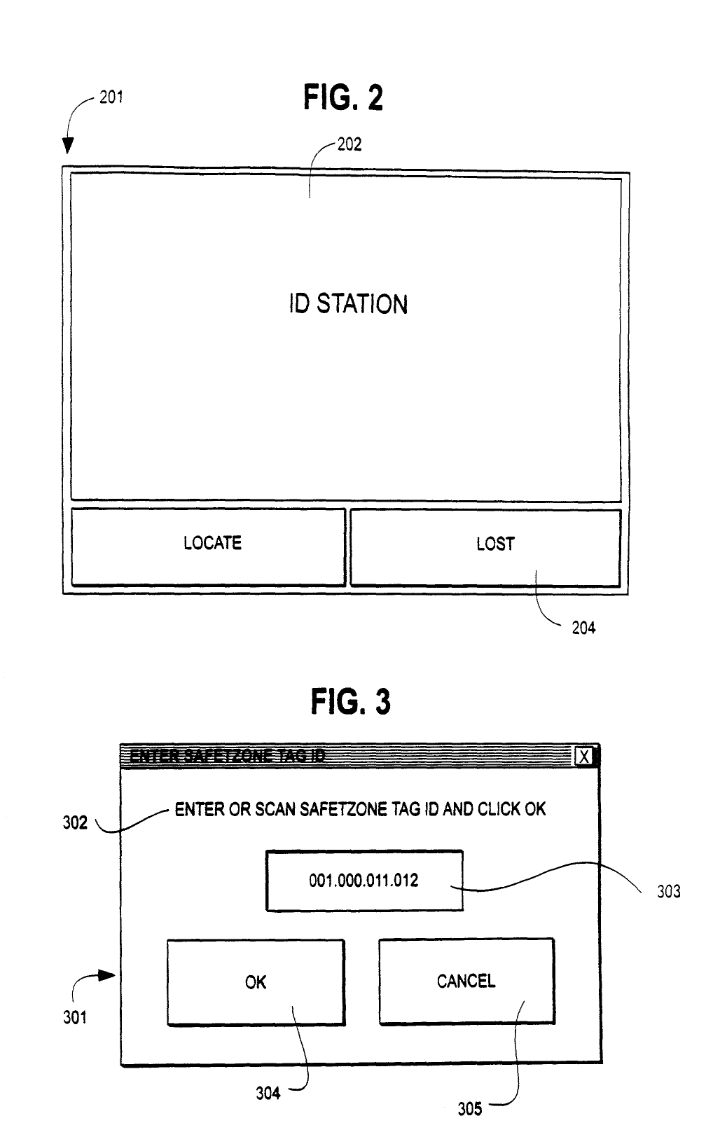

FIG. 2 is a schematic of a graphical user interface (GUI) 201 provided at each identification station 108, for example, for communication between the host computer and the individual user requesting location information. The GUI includes a large video screen 202 showing an opening screen that is displayed when the identification station is not in use. The opening screen may include the trade name of the product which is exemplified by the name “ID stations” shown in FIG. 2. “Locate” button 203 and “Lost” button 204 are shown below the video screen. These are “soft” buttons that are activated by pointing and clicking with a mouse or by use of a “touch screen.” An alternative embodiment uses “hard” buttons that can be physically depressed by the individual user. When approaching the GUI, the individual user will select one of the two buttons before providing information on the identification of the individual.

FIG. 3 depicts a dialog box 301 displayed on the video GUI of the identification station following the user selection of either the Locate or Lost buttons. The dialog box includes prompt 302 requesting entry of the tag serial number or scanning of the tag; a display 303 shows the identification number entered or scanned. Actuation of the “OK” button 304 completes the action while actuation of the “cancel” button deletes the dialog box. These are preferably soft buttons that can be selected using mouse or by a touch screen.

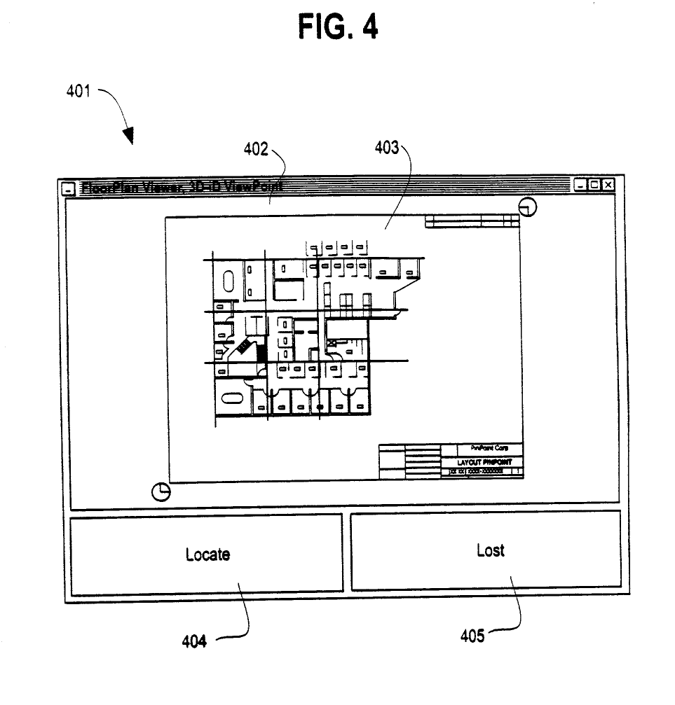

FIG. 4 depicts a further GUI video display 401 of the identification station. The GUI includes a large video screen 402 with map 403 of the environment where tracking is occurring. “Locate” button 404 and “Lost” button 405 are located below the video screen. As the system identifies the location of individuals of the group, an icon with a picture of the individuals is displayed on the map at their location. In an alternative embodiment, the picture can be replaced by symbol and the GUI can display a key that links the symbol with the name or picture of the individual.

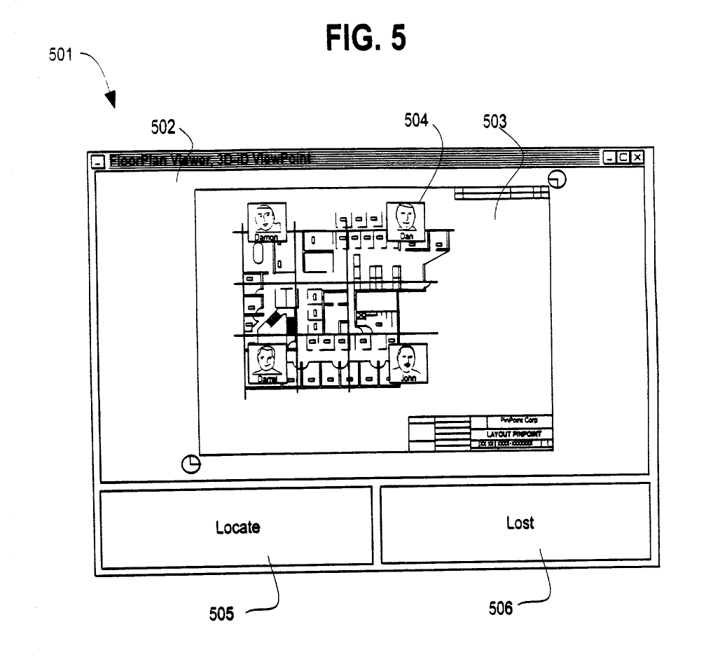

FIG. 5 depicts another GUI video display 501 of the identification station. The GUI includes a large video screen 502 with map 503 of the environment where tracking is occurring showing the identities and location of individuals 504 on the map. “Locate” button 504 and “Lost” button 505 are shown below the large video display.

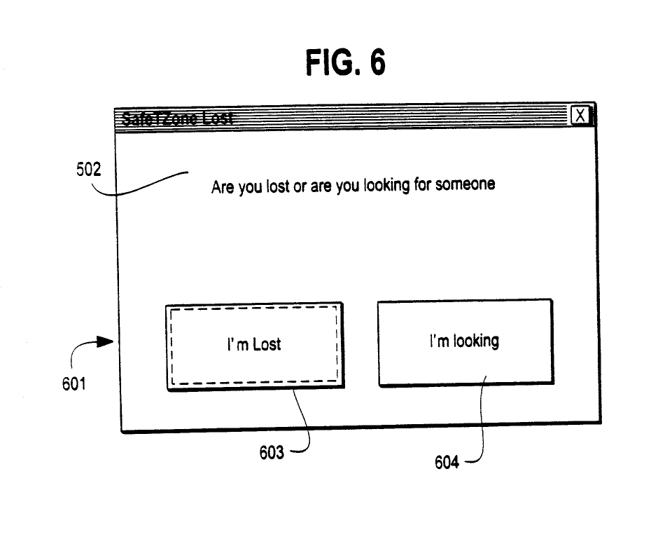

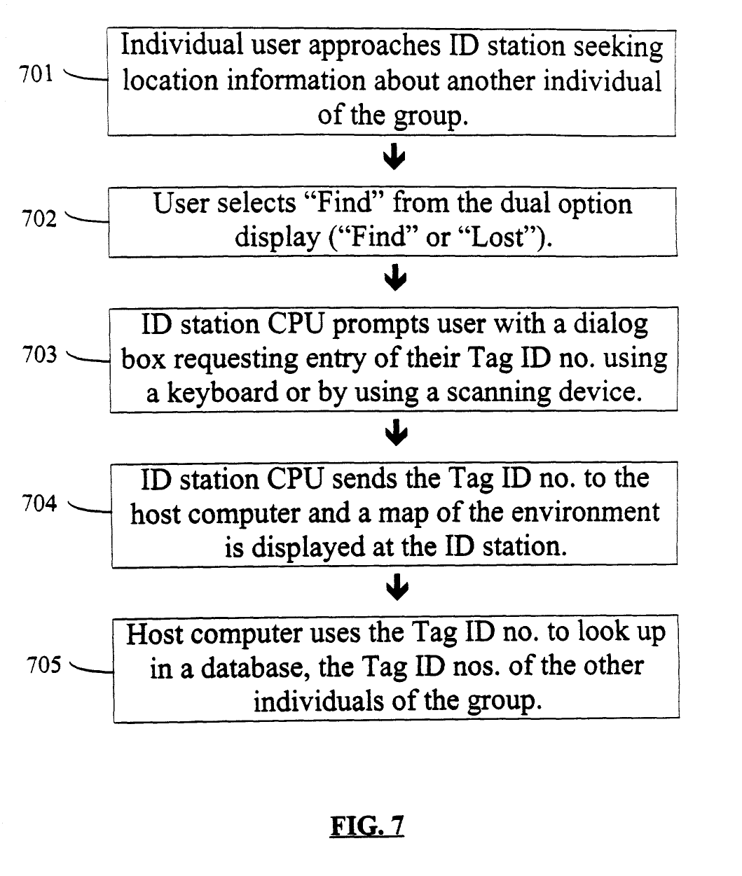

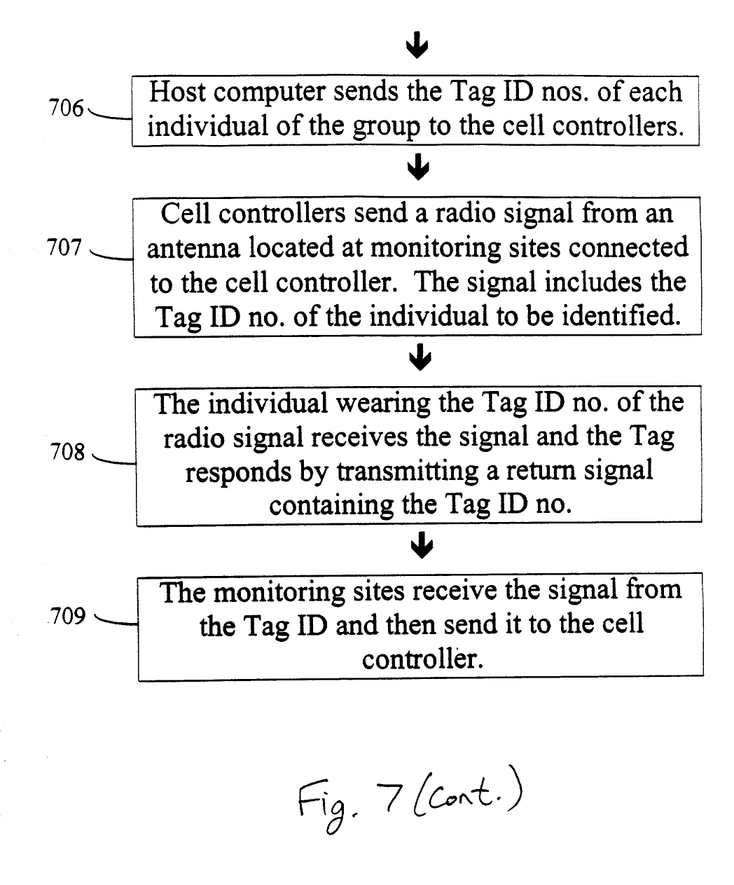

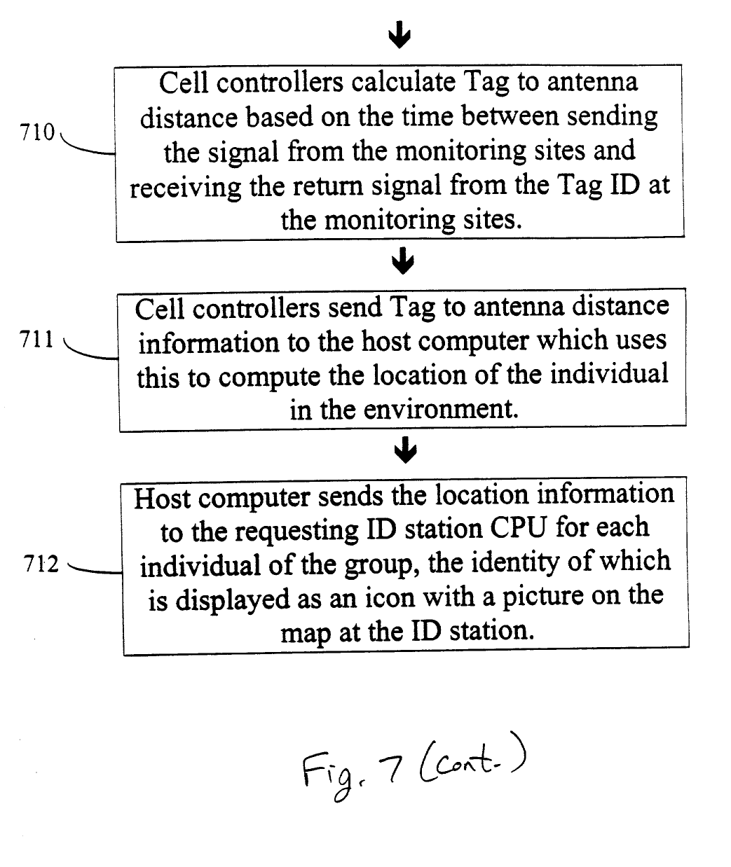

FIG. 6 depicts a dialog box 301 displayed on the video GUI of the identification station when the user selects the “Lost” button. The box includes prompt 602 requesting the individual to decide if he/she is looking for someone or is lost. Actuation of the “I'm Lost” button 603 prompts the individual to stay put and sends for security. Actuation of the “I'm Looking” button 604 activates the process to obtain assistance in meeting an individual of the group as described in more detail in FIG. 7.

FIG. 7 is a flow chart describing the flow of information from the identification station to the host computer when an individual user selects the “Locate” button at the identification station display. The user approaches the identification station seeking location information about a member of his/her group (shown as 701) and selects the “Locate” button from the selection display (shown as 702) of the GUI at the identification station. The identification station prompts the user with a dialog box (see e.g., FIG. 3) requesting entry of his/her tag serial number using a keyboard or using a scanning device (shown as 703). The scanning device is preferably a bar code scanner for scanning a bar code unique to each individual tag.

An identification station CPU sends the user tag serial number to the host computer (shown as 704) which uses the tag serial number to look up serial numbers of the tags of the other members of the group (shown as 705). The identification station then displays a bit map of the environment which is supplemented later by the information showing the location of individuals of the group. In an alternative embodiment, the bit map is displayed only with the location of the individuals of the group.

The host computer then sends the tag serial numbers of each individual of the group to the cell controller CPU (shown as 706) which then sends out a radio signal with the tag serial number for each individual from the antenna of each connected monitoring site (shown as 707). The individual wearing the tag with the corresponding serial number designated in the radio signal receives the signal and the tag responds by transmitting a return signal containing the tag serial number (shown as 708). The tags receive the radio signal at one frequency and the signal is returned by the transmitter in the tag at a different frequency.

The monitoring sites receive the return signal which is sent to the cell controller CPU (shown as 709), which calculates a tag-to-antenna distance (TAD) for each tag based on the time elapsed between sending the signal from the antenna and receiving a return signal from the tag (shown as 710). In an alternative embodiment, TAD data is calculated at the host computer. Cell controllers with monitoring sites and antennae are well known in the art and are available commercially such as the “Local Positioning System (LPS) cell controller system sold by Pinpoint Corporation, having a place of business at Billerica, Mass.

Cell controllers send the TAD distance information to the main server which computes the location of the tags having the specified tag serial numbers in the environment (shown as 711). The host computer then sends the location information of each individual to the requesting identification station CPU which displays a map showing the location of each individual of the group as an icon with their picture (shown as 712). The map may be displayed for about one to two minutes before reverting to the opening screen. The map will be removed earlier if a user selects the “Locate” or “Lost” buttons. The system may be calibrated to provide an accuracy of 10 feet or less and can update the location within seconds.

In another embodiment, each tag transmits a unique chirp at a regular interval of, for example, 7 seconds. The chirps are received by the antennae of the monitoring sites throughout the environment. The position of each user of a tab may, therefore, be continuously monitored by the host computer. When a user requests location information about other members of his/her group, the information is retrieved from a temporary storage, for example, of the host computer and is provided to the user at the identification station.

In one embodiment, the system retains the location information for each user for a fixed period. For example, the system may store the location information for a floating 10-minute period. Thus, if a user becomes lost or a tag ceases to function properly, the user's location may be retrieved for anytime within the fixed period. Further, a last known position may be stored in the event of a lost or malfunctioning identification tag.

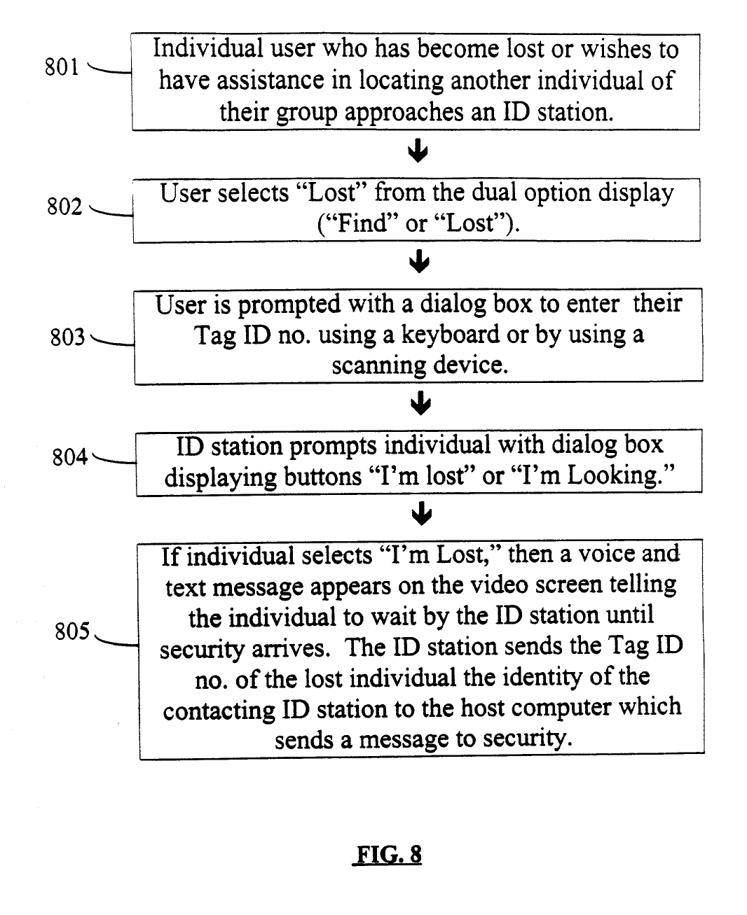

FIG. 8 is a flow chart describing the flow of information from the identification station to the host computer when an individual selects the “Lost” button at the identification station display. The individual user who becomes lost or is seeking assistance in meeting with another individual of the group approaches an identification station (shown as 801) and selects the “Lost” button from the option display (shown as 802). The identification station prompts the user with a dialog box (see e.g. FIG. 3) requesting entry of his/her tag serial number using a keyboard or by using a scanning device, for example (shown as 803).

The identification station then prompts the individual with a second dialog box (see, e.g. FIG. 6) displaying buttons “I'm Lost” or “I'm Looking.” If the individual selects the “I'm Lost” button, then the identification station displays a third dialog box (see e.g. FIG. 6) that asks the individual to confirm that they are lost or just looking to meet another individual (“I'm lost” or “I'm Looking”) (shown as 804). If the user selects “Lost,” the system will instruct the lost user in accordance with the procedures and guidelines of the facility as to how to proceed in this situation. This may include display of a text message and audio message that both of which tell the user to wait by the identification station until security arrives (shown as 805). The host computer preferably simultaneously alerts security by providing the identity of the contacting identification station and the tag serial number of the lost individual (shown as 805).

If the user selects “I'm Looking,” then the host computer uses the system as described and shown above with reference to FIG. 7 to determine the identity of all members of the group and sends a map for display at the identification station (shown as 806). The user then selects the individual they wish to meet by clicking or touching the icon of the appropriate individual on the map (shown as 807). The identification station responds with a voice and text message instructing the user that a security guard is being dispatched to the lost party and that the user should wait at the identification station (shown as 808).

The assignment of tags to individuals and of groups may be performed, for example, at an entrance to the environment. When individuals arrive at the environment, they may register their participation in the tracking system at a registration station. The registration-station is preferably a module that enables quick setup of groups and entry of individuals into that group. The subject module may be designed as a completely self-service station. An applet may be written to interface with a main software application on a main server The applet may reside in a Windows platform environment. The subject computer system may have pre-established grouping ability with simple function input of the individuals and their identification tag association.

Alternatively, the registration-station may be a Winterm station in a thin client configuration; thereby, providing easy maintenance and support. Its function is to provide an end user interface for users to set up and enter groups and eventually give access to allow customization of individual identities. Preferably, it should have one display button “Group Setup” on the first screen.

A method of “breaking out” or aborting may also be provided. Preferably, the program should only be aborted from the host computer. The registration station may provide a point-and-click user interface or may utilize touch screen technology.

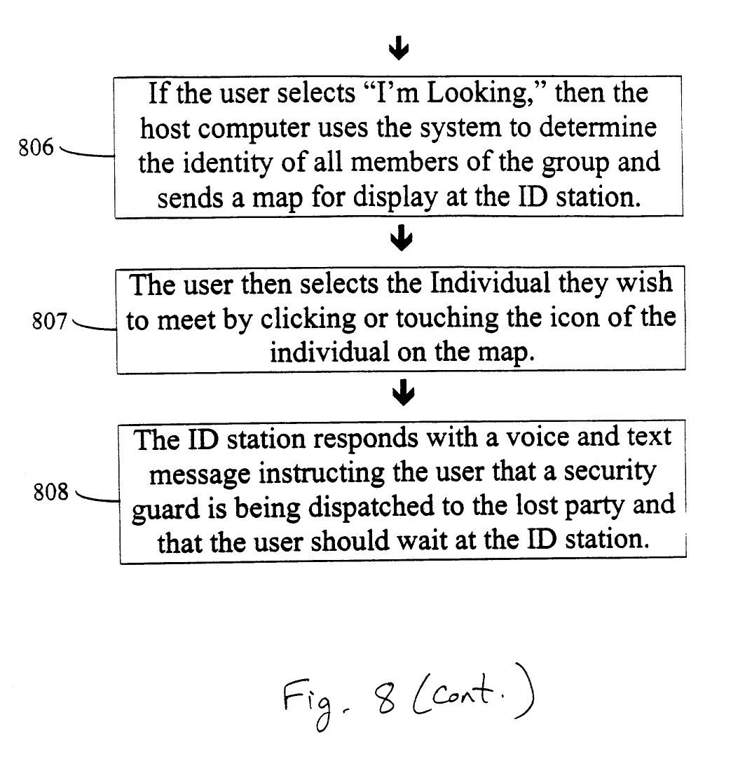

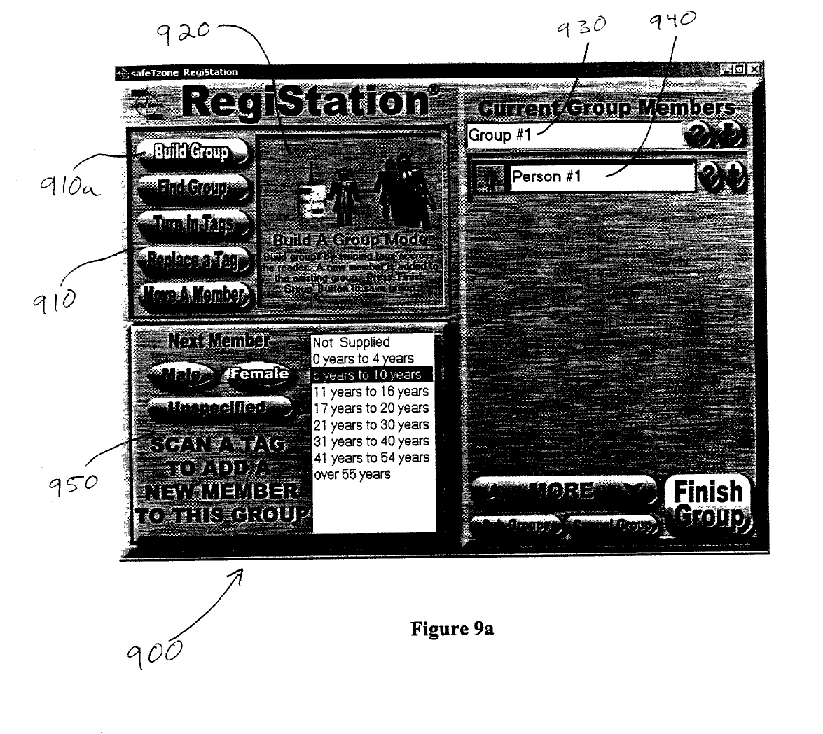

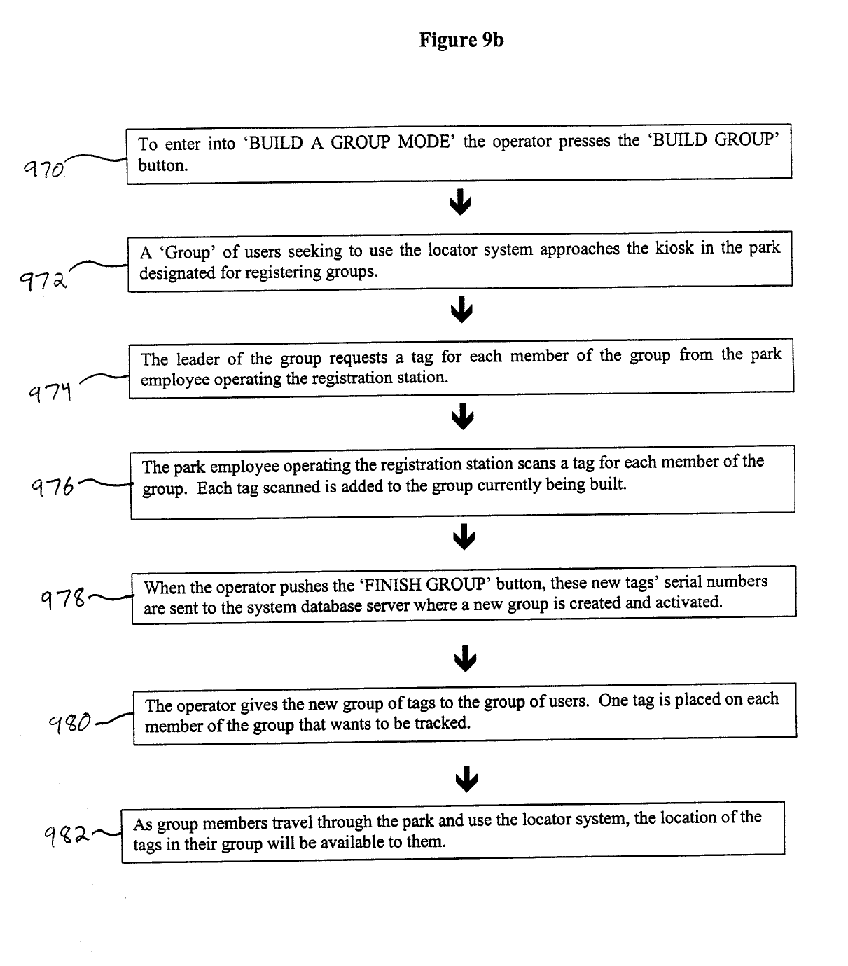

FIGS. 9a through 13b illustrate the operation of a registration station according to one embodiment of the present invention. FIGS. 9a and 9b illustrate the operation of the registration station during a group building mode. Referring first to FIG. 9a, a dialog box 900 on a graphic user interface (GUI) at a registration station is shown in a group building mode. The dialog box 900 comprises a menu portion 910 with a plurality of buttons for executing various functions. A “Build Group” button 910a is illustrated as highlighted in the group building mode. An instruction portion 920 provides assistance to the user by providing instructions on steps required from the user. A group identifier portion 930 is provided to identify the current group name, and an individual identifier portion 940 is provided to indicate the current individual user. Additionally, an individual demographic block 950 may be provided to allow specification of certain characteristics of the individual user. This information may be used for marketing purposes as will be described in detail below.

Referring now to FIG. 9b, the “Build Group” mode begins when an operator (an employee of an amusement park, for example) presses or selects the “Build Group” button 910a of the dialog box 900 shown in FIG. 9a (block 970). In a self-service embodiment, this step may be performed by a user who is a member of a group, for example. At block 972, a group of users of the location system approach the registration system seeking to register as a group of users. A member of the group requests an identifier tag for each member of the group (block 974). The operator scans a tag for each member of the group, entering the individual's information and the group's name into the appropriate portions of the dialog box 900 (block 976). The scanning may be a bar code scanning or other appropriate scanning. The individual's information may be associated with an icon or a digital picture of the individual, for example.

Preferably, one member of the group is designated as the group master. Only the group master may be allowed to make changes to the group information such as the name of the group and the designations for the individuals.

Once all the members have been assigned an identifier tag, the operator presses a “Finish Group” button of the dialog box 900, thereby causing the group and individual information and the associated tag serial numbers to a system database server (block 978). The tags are distributed to the members of the group (block 980), and the locator system allows the members to obtain location information for the other members of the group (block 982).

In a preferred embodiment, only members of the group can obtain location information for other members of the group. No other visitors may obtain access to this information. Similarly, the members of the group may only obtain information regarding members of their group.

In another embodiment of the invention, a group may be divided into subgroups within the group. Thus, certain members may create a smaller subgroup within the group.

In another embodiment, two or more groups may be merged at a later time. For example, some members of a group may arrive separately from other members and may register separately. At a later time, the two groups may be merged into a “super group”. The original groups may be retained as “sub groups” of the “super group”. Additional individual members may also be added to a group at a later time.

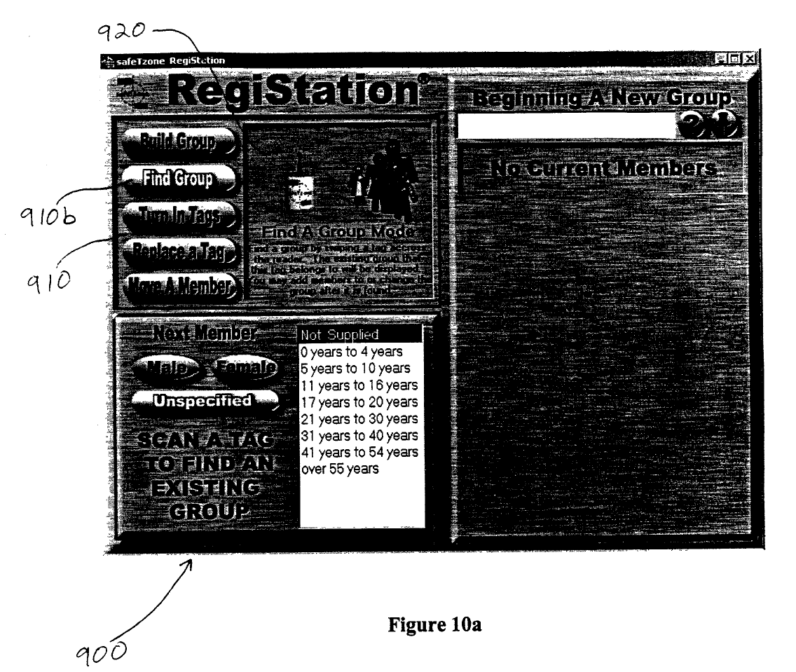

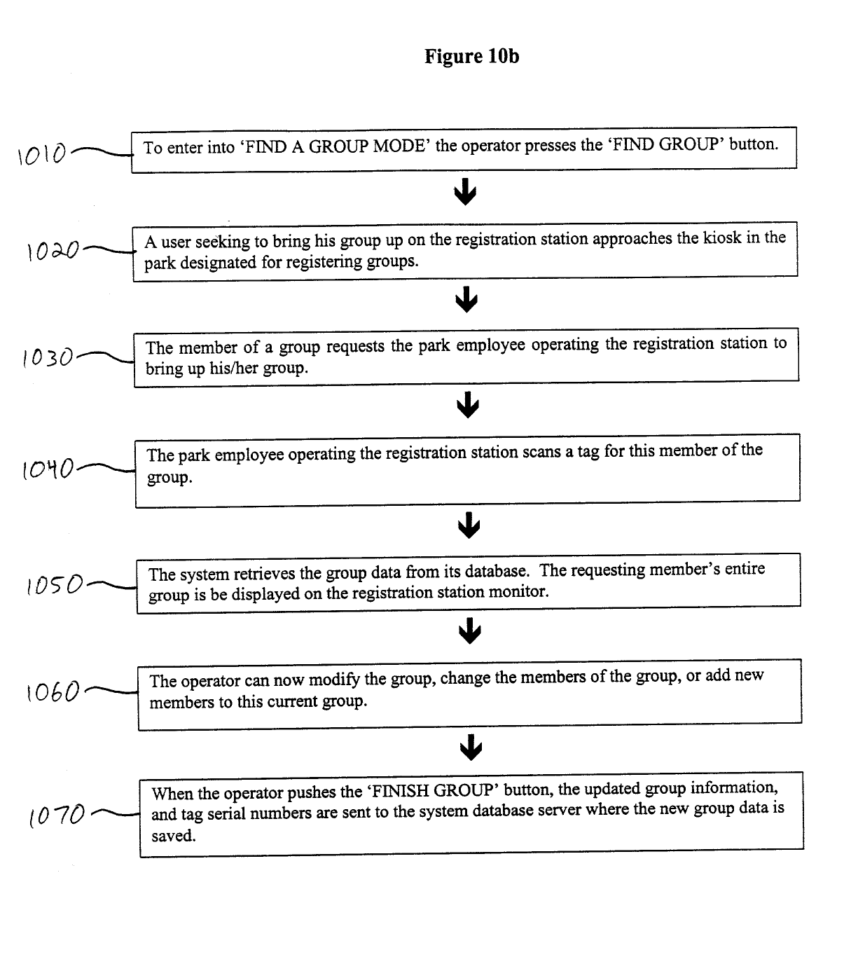

FIGS. 10a and 10b illustrate the operation of the registration station during a group finding mode. A “Find Group” button 910b in the dialog box 900 is illustrated as highlighted in the group finding mode. The instruction portion 920 provides information specific to the group finding mode.

Referring now to FIG. 10b, the “Find Group” mode begins when an operator presses or selects the “Find Group” button 910b of the dialog box 900 shown in FIG. 10a (block 1010). In a self-service embodiment, this step may be performed by a user who is a member of a group, for example. At block 1020, a user approaches the registration system seeking to find members of a group and requests the operator to display the location information of the members of his group (block 1030). The operator scans the user's tag (block 1040), and the system uses database information relating to the group, including the tag serial numbers, to display the positions of the members on a monitor (block 1050). If desired and/or permitted by the group master, for example, the operator may modify the group information, including adding or deleting members of the group. Once completed, the operator presses the “Finish Group” button (block 1070). As described above, the group finding function may be performed at self-service stations.

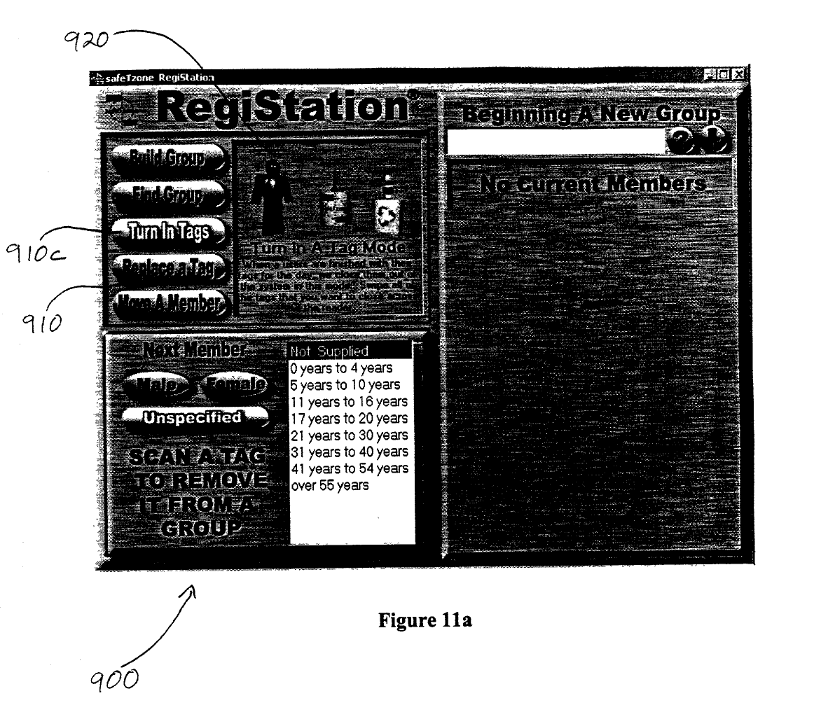

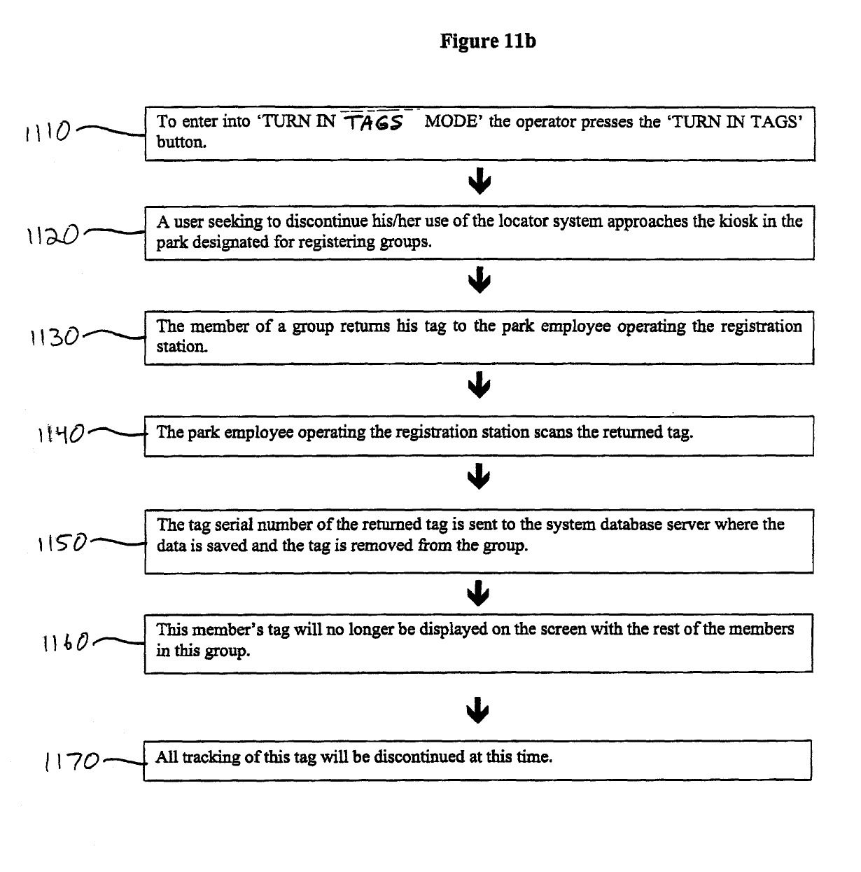

FIGS. 11a and 11b illustrate the operation of the registration station during a tag returning mode. This function may be used if, for example, the user desires to leave the park at the end of the day. A “Turn In Tags” button 910c in the dialog box 900 is illustrated as highlighted in the tag returning mode. The instruction portion 920 provides information specific to the tag returning mode.

Referring now to FIG. 11b, the “Turn In Tags” mode begins when an operator presses or selects the “Turn In Tags” button 910c of the dialog box 900 shown in FIG. 11a (block 1110). At block 1120, a user approaches the registration system seeking to discontinue his/her use of the identification tag and returns the tag to the operator (block 1130). The operator scans the user's tag (block 1140), and the system updates the database information to delete the user from the group (block 1150). The user is no longer displayed as a member of the group (block 1160), and all tracking of the tag ceases (block 1170).

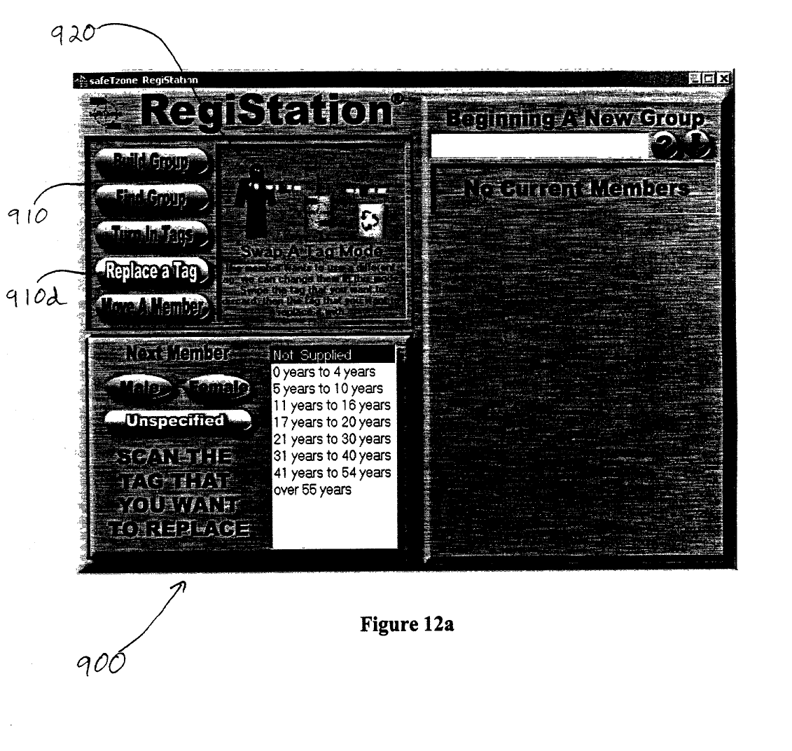

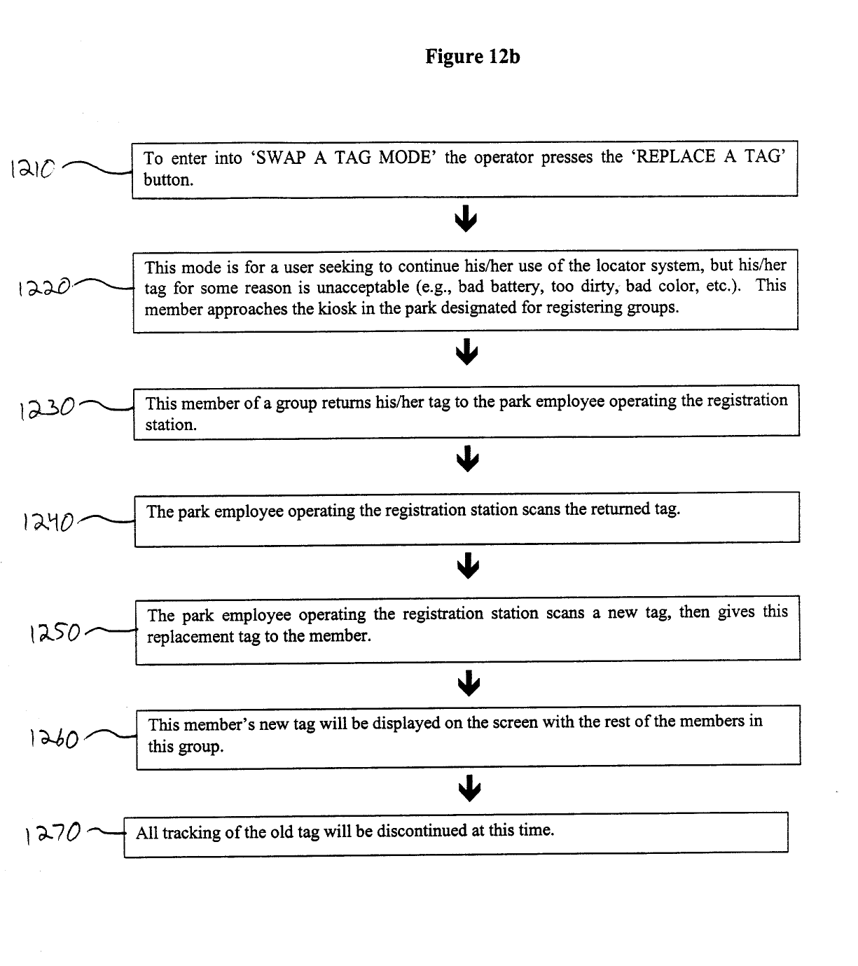

FIGS. 12a and 12b illustrate the operation of the registration station during a tag swapping mode. This mode may be used if, for example, an issued tag is malfunctioning or low on battery. A “Replace a Tag” button 910d in the dialog box 900 is illustrated as highlighted in the tag swapping mode. The instruction portion 920 provides information specific to the tag swapping mode.

Referring now to FIG. 12b, the tag swapping mode begins when an operator presses or selects the “Replace a Tag” button 910d of the dialog box 900 shown in FIG. 12a (block 1210). At block 1220, a user approaches the registration system seeking to exchange his identification tag and presents his tag to the operator (block 1230). The operator scans the user's returned tag (block 1240) and scans a new tag (block 1250). The system updates the database information to modify the tag serial number associated with the user. The user continues to be displayed as a member of the group (block 1260). All tracking of the returned tag ceases (block 1270), and the system now tracks the newly issued tag.

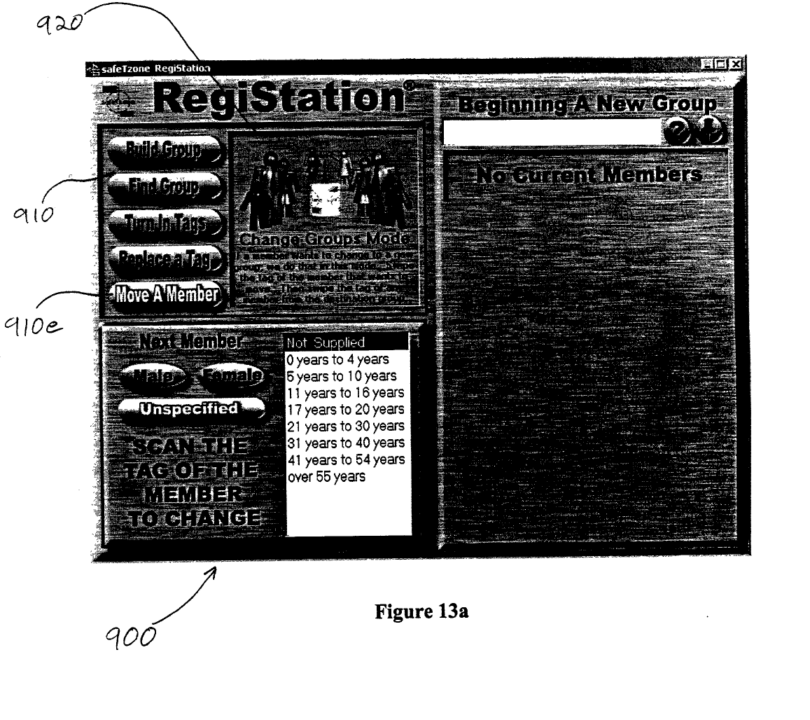

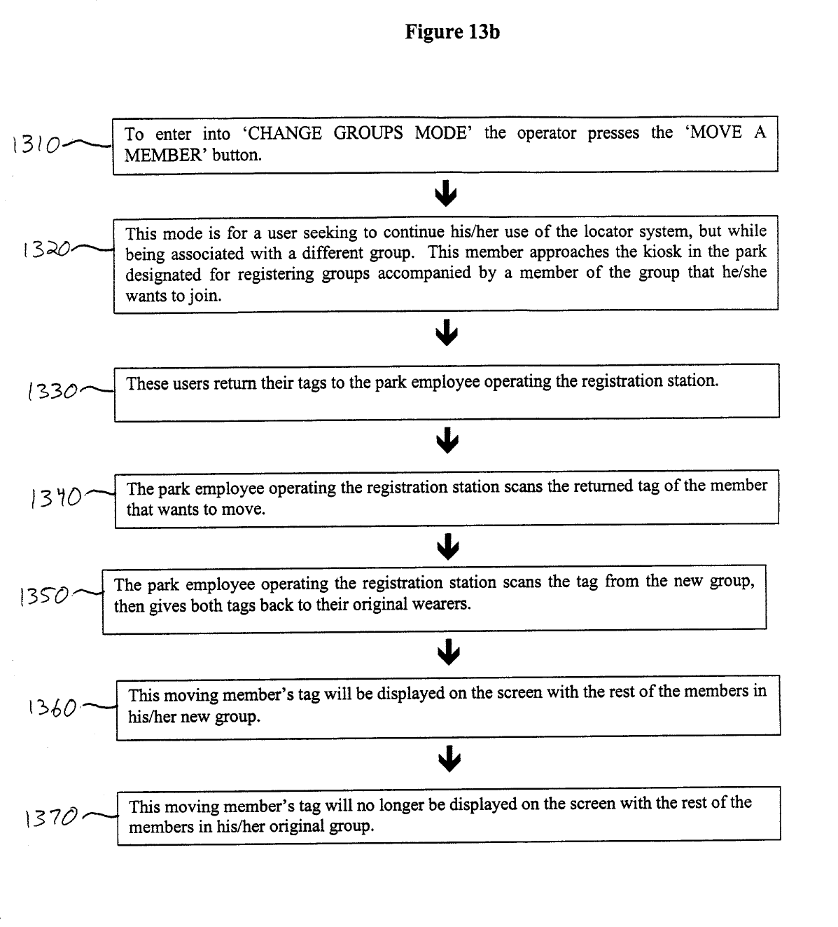

FIGS. 13a and 13b illustrate the operation of the registration station during a group changing mode. This mode may be used if, for example, a member of one group seeks to disassociate with the group and instead become associated with a second group. A “Move a Member” button 910e in the dialog box 900 is illustrated as highlighted in the group changing mode. The instruction portion 920 provides information specific to the group changing mode.

Referring now to FIG. 13b, the group changing mode begins when an operator presses or selects the “Move a Member” button 910e of the dialog box 900 shown in FIG. 13a (block 1310). At block 1320, a user approaches the registration system seeking to disassociate with his current group and become associated with a second. In a preferred embodiment, the user is accompanied by a member of the second group. In another embodiment, the masters of both groups must be present to approve the change.

The user and the accompanying second group member present their tags to the operator (block 1330). The operator scans the user's returned tag (block 1340) and scans the tag belonging to the member of the second group (block 1350). Both tags are returned to their respective wearers. The system updates the database information to modify the group information of both groups by deleting the user from his original group and adding him to the new group. The user is now displayed as a member of the second group (block 1360). The user is no longer displayed as a member of his original group (block 1370).

The demographic information collected during the registration process (e.g., the group building mode) may be used in a variety of ways. The information may be collected either during the registration process or may be collected beforehand if the user is, for example, a season pass holder. Collecting the information beforehand may accelerate the registration process for the user.

The demographic information may be combined with tracking information for marketing purposes, for example. In this regard, the system may store the user's position in the environment for an entire day. The information may be used, for example, to determine where certain individuals go for entertainment within the environment and how long they stay at each attraction. Such information may be useful for targeted advertising at each attraction. For example, the information may be used to determine which attraction draws a younger age group so that products targeting that group may be advertised at that attraction.

One embodiment of the present invention allows users to transmit messages to the other members of the group. A user may use an identification station, for example, to enter a message for the other members of the group. The system then transmits a signal to the identification tags of each of the other members causing the tags to, for example, light up or beep, indicating an awaiting message. The other users may proceed to the nearest identification station to view the message.

Another embodiment of the invention allows tracking of specific personnel or equipment. For example, the location of all security guards or custodians may be made available to a park administrator. Thus, the park administrator may efficiently dispatch the closest security guard to a required location.

The present system can be used to improve safety of children particularly at large facilities such as theme parks or casinos because it can locate children, parents and even employees on a real time basis. These and other benefits include:

Safer environment for children which gives parents peace of mind during their visit.

Allows patrons access to the system and its information and the ability to locate a person quickly and easily through the ID stations. This saves valuable time, effort and energy.

Provides authorities with the ability to determine quickly if a patron has wrongly entered a restricted area.

Useful to track individuals in a large group (e.g. groups of tourists or large parties) who often separate from one another during their visit. Members of the group can quickly locate other members of their party to meet or in the case of an emergency.

Provides security personnel with the ability to quickly come to the aid of missing children or parents and to assist in reuniting them.

Assists in compliance with regulatory agencies and insurance firms and in lowering insurance premiums

Provides data for market research by being able to track the movement of customers in the business.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

What is claimed is:

1. A method for tracking in real-time the location of a group of members within a defined environment and for providing information to any member of the group about the location of any other members of the group, comprising:
providing each member with an identification tag, each tag having a unique serial number;
associating each member with the group and with the unique serial number;
communicating with each tag as said members move within said defined environment, said communicating providing information indicative of said unique serial number; and
determining location information of each member from said communicating.

2. A method in accordance with claim 1, further comprising:
requesting location information of each member by a requesting member; and
providing said location information of each member to said requesting member.

3. A method in accordance with claim 2, wherein said providing said location information comprises displaying a map of said defined environment on a monitor and an indication of each member on said map.

4. A method in accordance with claim 2, wherein said requesting comprises interaction between the requesting member and a graphical user interface.

5. A method in accordance with claim 4, wherein said graphical user interface comprises a touch screen system.

6. A method in accordance with claim 1, further comprising storing said location information of each user for a fixed period.

7. A method in accordance with claim 1, further comprising obtaining demographic information for each member of said group.

8. A method in accordance with claim 7, wherein said demographic information includes age of each member.

9. A method in accordance with claim 1, further comprising associating each member with an icon for representation on a monitor.

10. A method in accordance with claim 1, further comprising:
returning a tag provided to a member; and
disassociating said member from said group.

11. A method in accordance with claim 1, wherein said disassociating includes deleting said member from a member list associated with said group.

12. A method in accordance with claim 1, further comprising:
returning a tag provided to a member;
disassociating said member from said unique serial number of said tag;
providing said member with a new tag having a new serial number; and
associating said member with said new serial number.

13. A method in accordance with claim 1, further comprising:
disassociating said member from said group; and
associating said member with a new group.
